(19) United States
(12) Patent Application Publication
(10) Pub. No.: US 2004/0051206 A1
(43) Pub. Date: Mar. 18, 2004

(54) One pound density foam/cemititous waterfalls

(76) Inventor: Darren Lee Nolan, Sarasota, FL (US)

Correspondence Address: Darren L. Nolan, 7386 North Lockwood Ridge Road, Sarasota, FL, 34243, US

(21) Appl. No.: 10/245,105

(22) Filed: Sep. 17, 2002

(51) Int. Cl. B28B 7/22

(52) U.S. Cl. 264/255

(57) ABSTRACT

The foam and cemitious waterfalls that are produced in the invention process are lighter than natural stone and have the appearance of natural stone.

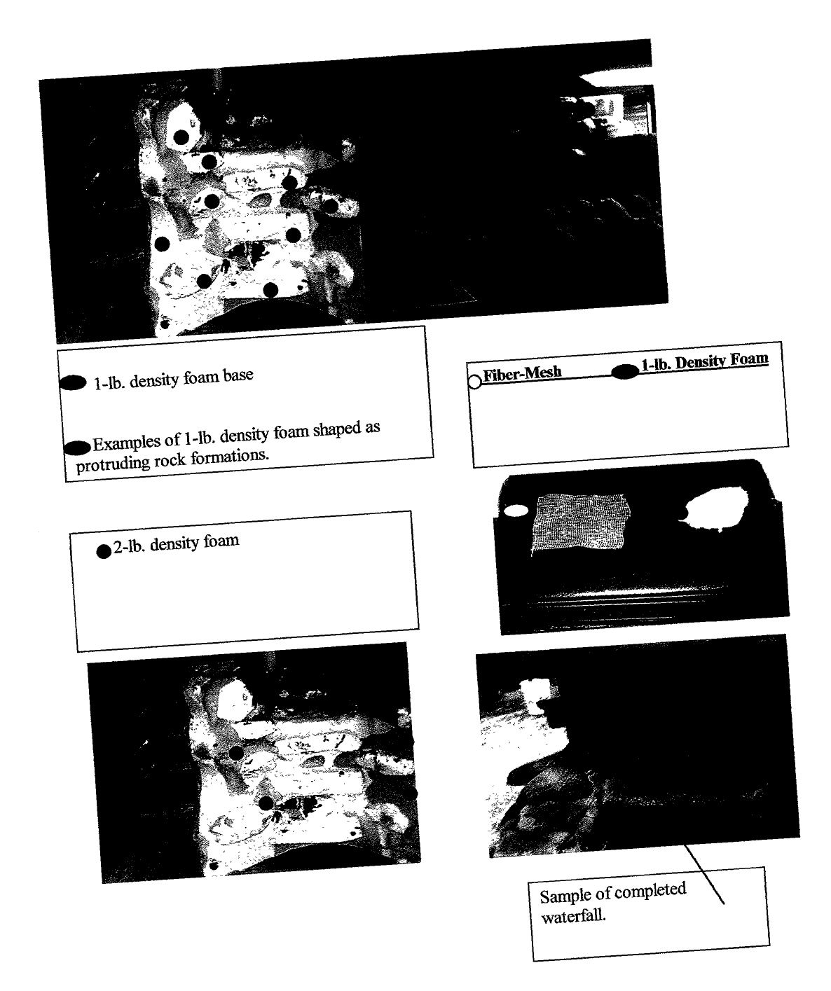

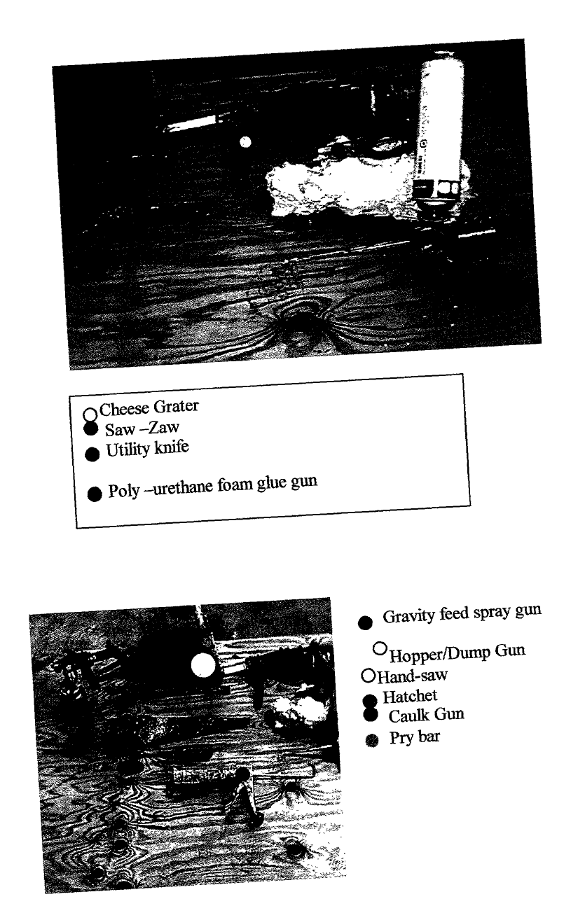

The cost of creating waterfalls in this way saves time and money. The process consists of carving 1-lb. density foam into any waterfall shape, adding irregular foam shapes to outside of feature with polyurethane based glue.

A self-adhesive mesh is applied; rubber liner installed in mote and the final process is a cemitious coating with color pigment is applied to mesh.

The end result is a rock like water feature.

The invention that we are describing herein is the sole property of Darren L. Nolan.

I Darren L. Nolan have invented a process in making waterfalls of all shapes and sizes, all colors to be installed in any location imaginable.

The waterfalls constructed are 1pound and 2pound density foam, reinforced with a fiber-mesh cloth and coated with a cemitious material.

Step 1. Measure and design proposed water feature by sketch, drawing or 3-d computer design.

The usual design is a back drop rock water feature of varying height, slope, pitch, design, etc. that will have the water dispersing off of it and downward into the second half that retains the water calling this part a mote.

(Whatever height and width dimension of the vertical foam back drop or waterfall, the same dimensions at least should be applied to the mote size.)

The two piece foam design entails gluing two large blocks of 1 lb.density foam together of varying sizes and dimensions, one placed horizontal on the ground (mote) and one vertical which would be the back drop, waterfall or proposed rock like feature.

The two blocks of 1-lb. density foam are glued together with polyurethane foam based glue.

Step 2. Measure and cut mote in top of backdrop, vertiical foam block, make sure you leave a 2-3 inch wall of foam on circumference.

The depth and width of cut in top mote will vary depending on design.

Step 3. Carve Ledges from top to bottom of vertical foam face stepping downward and outward this is where the water will flow from the top of feature to mote.

(If one decides to carve ledges from separate pieces of foam and then apply to vertical backdrop this can be done using the polyurethane foam glue.)

The tools needed to carve the foam are as such.

Chainsaw, saw-zaw, jigsaw, hobby knifes, handsaws, dremel, cheese grater tool for shaping, hatchet, pry bar, crow bar, polyurethane foam based glue gun, air compressor, etc.

Step 4. Carving separate pieces of foam into different shapes and sizes will be the process in creating protruding rock like features from the waterfall.

These individual pieces of foam will be glued to the base structure foam, giving the appearance of rock shapes.

The glue is polyurethane foam based glue applied with a special application gun.

Step 5. Plumbing must be installed from discharge side of pump, imbed in vertical face of foam and end discharge in top mote of waterfall or vertical foam block.

The pump is installed in the mote and has a pre-screen filter on the suction side of pump.

The pump does not necessarily need to be installed in the mote; it can also be on the exterior of water feature.

Our waterfalls are designed with a pump that has a suction and discharge side.

Step 6. Two-pound density foam is applied to exterior joints of protruding 1-lb. density foam to give additional support.

The 2-lb. density foam can be applied to the back of the feature and anywhere one may want a poured rock look.

This foam is two-component foam, mixing part A with part B of equal proportions. The foam can be poured or applied with a plural component system.

Step 7. Smooth any rough edges of foam with cheese grader tool and create cracks and crevice appearance in foam by using dremel, knife, hatchet, saw, pry bar, cheese grater etc.

Digging a hole in the horizontal foam block and gluing variable dimensions of foam to outside and top edges of horizontal block of foam create the mote.

The mote can be cut in different shapes and does not necessarily need to be a block form. (Triangle, circle, oval, etc.)

Step 8. Apply 2-lb. density liquid foam as mentioned above for backdrop feature. Smooth rough edges with above mentioned tools as desired.

Step 9. Apply fiber-meshed, self-adhesive cloth to completed foam feature. (Basically cut material from roll and place adhesive side to foam covering all sides and all areas of foam.)

(Mesh can be substituted for a spray, brush or roll on applied polyurethane liquid coating, to be applied to all areas of the foam.)

### Part-2 Instructions for Maui Creations Inc.

### Procedure of creating artificial rock/waterfalls

Step 10. Mix cemititous material with recommended amount of water in wheel barrel or mixer. (Don't add any aggregate on first coat!)

Step 11. The next step is to apply the first coat of cemititous coating to the foam feature.

This material can be applied by hand, brush or sprayed by a texture gun, dump gun, hopper gun, etc. (Let dry for 4 to 24 hrs.)

Step 12. Mix cemititous material with water and desired base color pigment, apply to entire waterfall/rock feature. (Let dry for 24 hrs.)

Step 13. At this point the rubber or plastic liner can be applied to mote.

Cut and place 10-12 mil. rubber/plastic liner material in mote, make sure it covers entire mote.

Use polyurethane caulking between liner and cemititous mote.

(Let dry for 24 hrs.)

Step 14. Mesh over liner and trowel heavy coat of cemititous material over mesh. Let dry for 24 hrs.

Step 15. Mix cemititous material, desired colored pigment and sand.

Apply to entire waterfall/rock feature. (By this point you should not be able to see the fibered mesh applied to foam.)

Step 16. While the third cemititous, applied coating is still wet; apply desired colored release agents for highlighting the waterfall/rock feature.

(The release agent can be applied by hand, dispersing colors where desired.)

Step 17. This third coat should set for 1-24 hrs. Depending on weather conditions and then rinsed thoroughly with water.

The purpose is to rinse excess amounts of release agent color from the waterfall/rock feature.

The end result will be the release agent trapped in lower areas of the feature to high light.

This process can be repeated with different colors until you get the desired color combination. (Once satisfied with the color and you rinse with water for the last time, let dry 24-48 hrs.)

Step 18. After the feature is completely dry, spray a light coat of aliphatic flat clear coat over entire waterfall/rock feature.

Application of this clear is usually applied with a gravity feed spray gun.

The end product should look like rock and have a deep rich color.

All tools needed in these procedures are pictured and attached to same.

1. I Darren L. Nolan claim to have invented a process of creating rock like features such as waterfalls, rocks, etc. From 1 lb. and 2-lb. density foam materials, applying a fiber mesh material for reinforcement and applying a cemititous material over foam and mesh to create end product.
This process, which is described in detail within this application, is my sole invention.
I have developed this process starting in 1998 and have reached the perfected procedure described within by the year 2000.
I seek a patent on this process to protect my rights to this procedure.
